(19) United States
(12) Patent Application Publication
(10) Pub. No.: US 2011/0164138 A1
(43) Pub. Date: Jul. 7, 2011

(54) Process for the Automatic Conversion of Film Images into Programmable OOP Objects for Movie

(76) Inventor: Toussaint Taliaferro Tyson, Apollo Beach, FL (US)

(21) Appl. No.: 12/651,500

(22) Filed: Jan. 4, 2010

(51) Int. Cl. G06K 9/00; H04N 5/30

(52) U.S. Cl. 348/162; 382/103; 348/E05.085

(57) ABSTRACT

A process is described comprising the preparation of subject objects with special colors that are invisible to the human eye, use of paired cameras to capture the subject object(s), use of pattern recognition software to merge the images. The merged image when accompanied by with behaviors will allow the creation of an OOP object that will facilitate automatic creation of animation-like special effects and CGI-like special effects.

### FIELD OF INVENTION

This invention relates generally to the production of digital film. More particularly, the invention relates to an improved process and system to turn each frame of film into a program, for example, an OOP object, or other digitally manipulatable format allowing any change made to an object in one frame of film to remain with that object in all subsequent frames of the film.

### THE STATE OF THE ART

The illusions used in the film, television, theater, or entertainment industries to simulate the imagined events in a story are traditionally called special effects (a.k.a. SFX, SPFX, or simply FX).

Special effects are traditionally divided into the categories of optical effects and mechanical effects. With the emergence of digital film-making tools a greater distinction between special effects and visual effects has been recognized, with “visual effects” referring to digital post-production and “special effects” referring to on-set mechanical effects and in-camera optical effects.

Optical effects (also called photographic effects), are techniques in which images or film frames are created photographically, either “in-camera” using multiple exposure, mattes, or the Schüfftan process, or in post-production processes using an optical printer. An optical effect might be used to place actors or sets against a different background.

Mechanical effects (also called practical or physical effects), are usually accomplished during the live-action shooting. This includes the use of mechanized props, scenery, scale models, pyrotechnics and Atmospheric Effects: creating physical wind, rain, fog, snow, clouds etc. Making a car appear to drive by itself, or blowing up a building are examples of mechanical effects. Mechanical effects are often incorporated into set design and makeup. For example, a set may be built with break-away doors or walls, or prosthetic makeup can be used to make an actor look like a monster.

Since the 1990s, computer generated imagery (CGI) has come to the forefront of special effects technologies. CGI gives film-makers greater control, and allows many effects to be accomplished more safely and convincingly—and even, as technology marches on, at lower costs. As a result, many optical and mechanical effects techniques have been superseded by CGI.

Motion capture, motion tracking, and mocap are terms used to describe the process of recording movement and translating the movement into a digital model. It has military, entertainment, sports and medical applications.

Each of the above has limitations, which limitations are a function of whether the effect is an optical effect or a mechanical effect. Film (optical) effects, such as mocap are often slaved to the program; and special (mechanical) effects are often very labor intensive, and, therefore, very expensive; certain labor intensive special effects requiring the creation of thousands of frames of medium can be very expensive. For example, optical effects are the most limited because they cannot be used to create the realistic visual sensation of a three dimensional object like a monster or a space ship. Mechanical effects are expensive and, in the case of explosive, and similar effects, dangerous. Computer generated imagery lacks a realistic visual feel unless made very expensively.

An image that is a program, i.e., and OOP object already possessing state and behavior, could be programmed to automatically make that image do what is needed and do it inexpensively. However, an image lacks state; and without state it cannot be given a behavior. And, of course, without a both state and behavior the image is not a programmable object. The difficulty lies in finding a way to give an image state. The invention resolves this difficulty and allows any change inserted into a frame of film to continue into all subsequent frames, as needed.

### SUMMARY OF INVENTION

The main purpose of this invention is to provide a technique for preparing an object for filming, and a filming and processing of the object(s) to create OOP object(s), or similarly manipulatable format. This process will have the benefits of animation and CGI, with very little of the manpower costs. Additionally, the OOP object will look as real as the detail and quality of the model will allow. Accordingly, each resulting OOP object can then be flexibly and inexpensively used to provide the necessary visual effects for a movie, video game, or other purposes.

Each resulting OOP object can be automatically added, or taken away from a frame or set of frames. Each resulting OOP object can be morphed, including: reduced in size or increased in size, given an entirely new shape and/or texture, given a change of color and/or reduced in visibility, etc. Additionally, each OOP object/manifestation can also interact with any other OOP object in a given frame. In short, the limitations of any OOP object related to the process are a function of the limitations of the programmer's imagination and talent.

For ease of understanding the process and the system, please note the following use of language. An “object” is anything capable of capture; the object can be any in any form of matter. A “captured object” is any object that has been captured by one or both cameras that are part of any set of paired cameras; an “image” is also a captured object. An “OOP object” is the product of a complete set of images after the set has been resolved, frame by frame, by pattern recognition and/or other program; the OOP object will be stored in a database for retrieval or morphing and later retrieval, as appropriate. An “OOP manifestation” is the representation of the OOP object in a particular frame. Thus, while the OOP object might comprise one (or more) sets of over three hundred OOP manifestations per set, usually one OOP manifestation will be in a given frame; however, this patent application often uses the word “OOP object” and “OOP manifestation” interchangeably for simplicity, but the context should clarify the meaning.

### BRIEF DESCRIPTION OF DRAWINGS

For a better understanding of the invention, as well as other objects and features thereof, reference is made to the detailed description of the invention to be read in conjunction with the accompanying drawing, wherein:

FIG. 1 shows examples of the two types of colors that are important to the system. Some colors are invisible to the human eye; some are not. Of course, FIG. 1 does not exhaust the spectrum of available colors.

FIG. 2 shows two kinds of paired cameras; it also shows a cube that is painted with four colors. The color which is visible to the human eye is color 107; the three colors 101, 102 and 103 are invisible to the human eye.

FIG. 3 shows three panels. In Panel A, a man's arm is painted with several colors. This panel also shows a paired camera. This panel will be used to show how the invention can be used to show how to prepare the arm and to film it. Panel B shows how to use the invention to “sever” the lower part of the arm during computer manipulation of the OOP object (i.e., the arm). Panel C shows the OOP severed arm from a different perspective from the perspective shown in Panel B.

FIG. 4 shows two panels that are used to show how an OOP object can be morphed. Here a five fingered human hand is prepared in Panel A. Panel B shows that same hand as an OOP three fingered alien hand after morphing.

FIG. 5 shows two panels that are used to show how the invention can use an OOP sphere to depict an OOP spherical spaceship blowing up. Panel C is used to show the flight path of the same spaceship.

FIG. 6 shows the same flight path (of FIG. 5, Panel C) by showing where the spaceship is in a particular frame of the film.

FIG. 7 shows how an OOP spherical ball can be morphed into a different form.

FIG. 8 shows three panels that are used to show how something can be added to an OOP object. In this case, it is an OOP cyclopean third eye.

FIG. 8 shows three panels that are use to show how the invention can be used to introduce a new OOP object and move that object among objects. In this case, it is an OOP helicopter. In Panel B, the OOP helicopter is shown moving in front of the building. In Panel C, the OOP helicopter is shown crashing into building.

### DESCRIPTION OF INVENTION

1. The process uses, usually non-toxic, pigments or dyes to paint the subject object

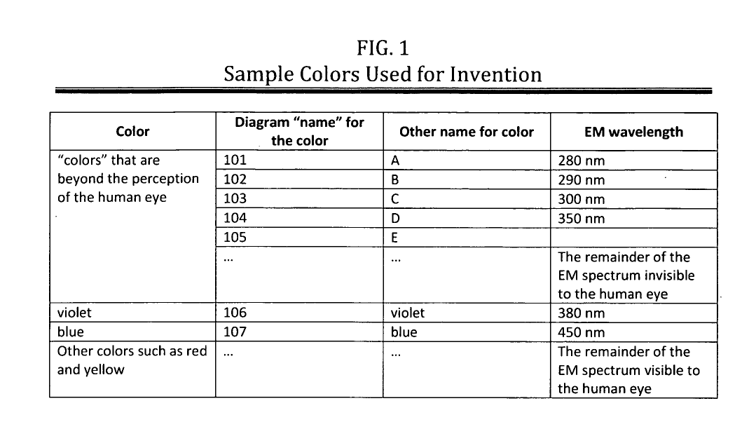

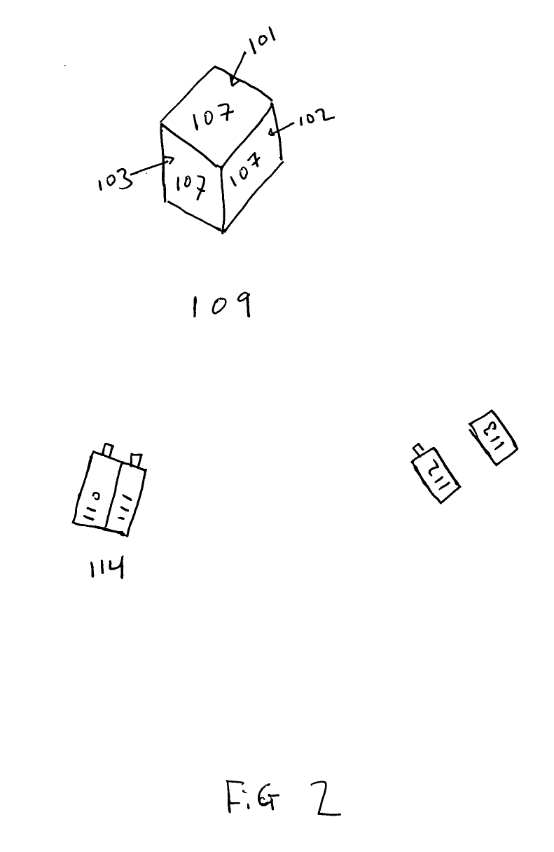

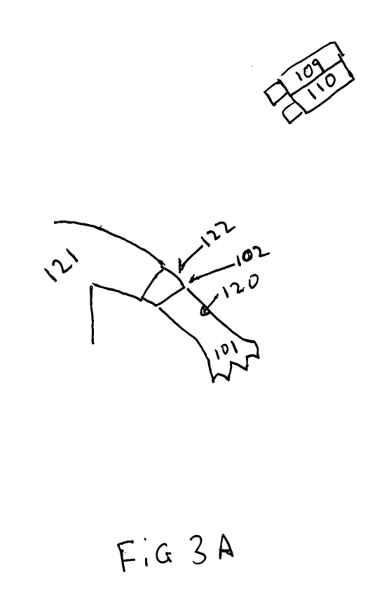

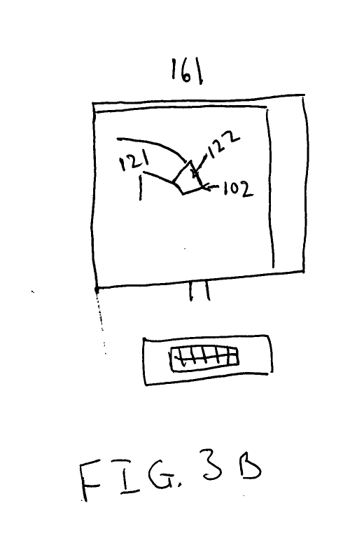

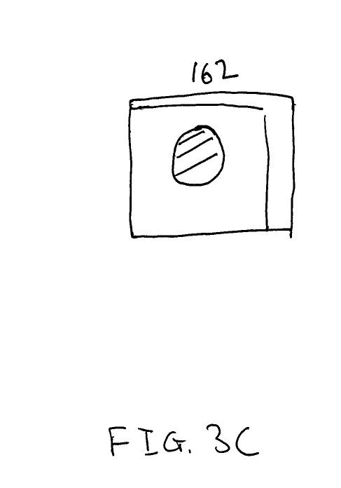

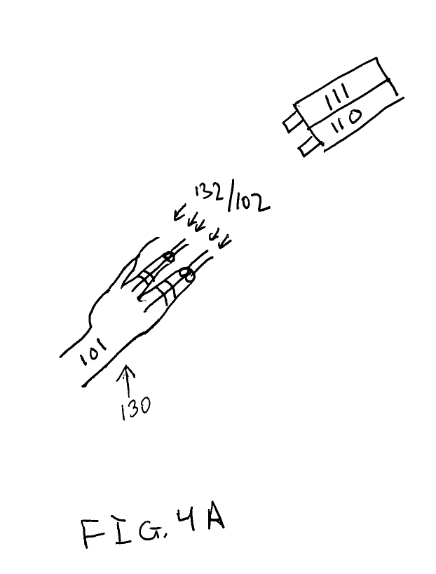

The pigments (see FIG. 1), for example pigments 101, 102, 103 or 104, inclusively, must be invisible to the human eye and must be capable of capture by (see FIG. 2) invisible pigment camera 110 or 112.

In certain cases, a plurality of invisible pigments may be used.

The subject objects(s) can be condensed matter any other matter.

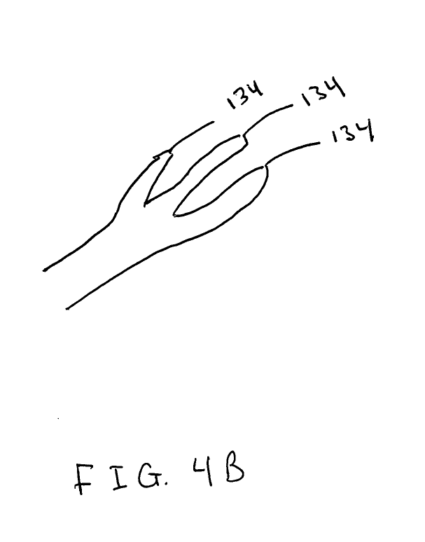

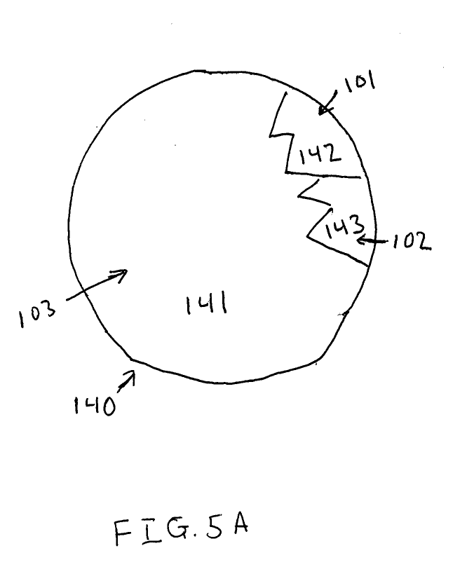

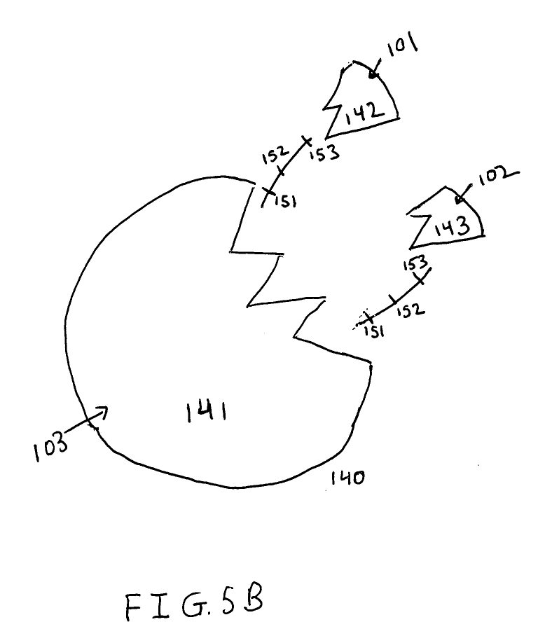

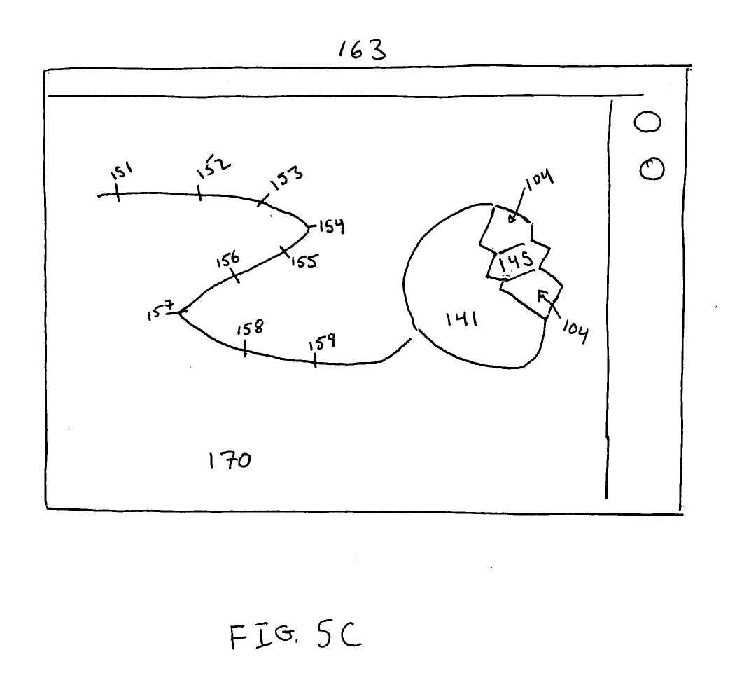

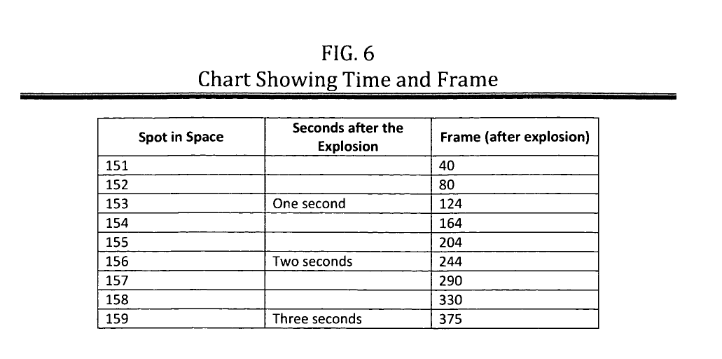

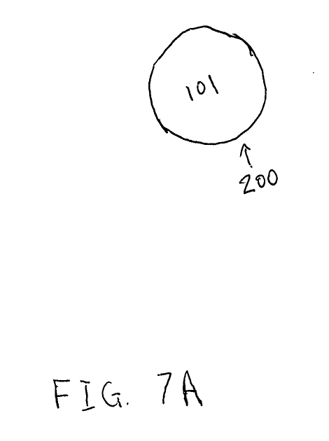

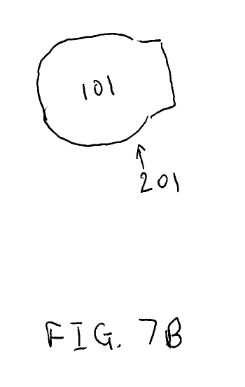

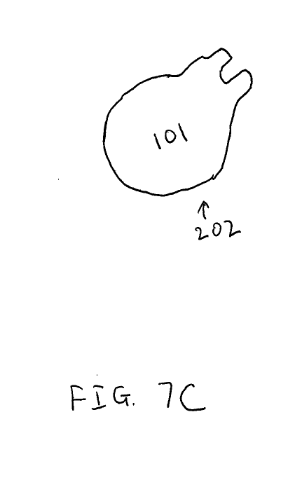

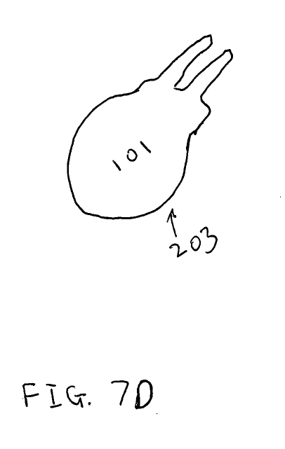

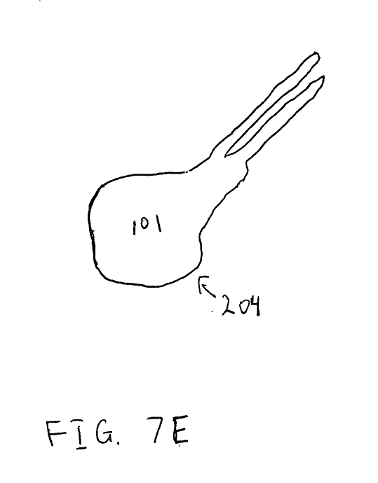

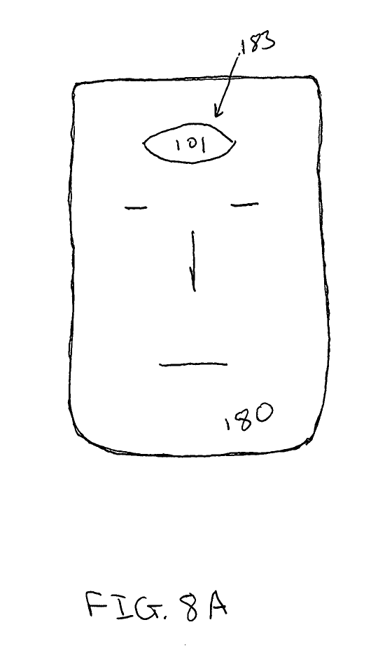

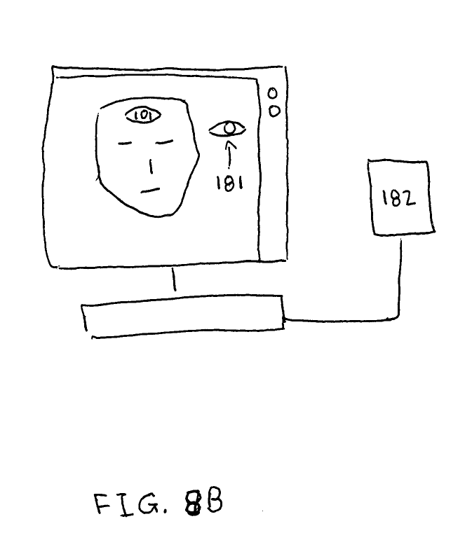

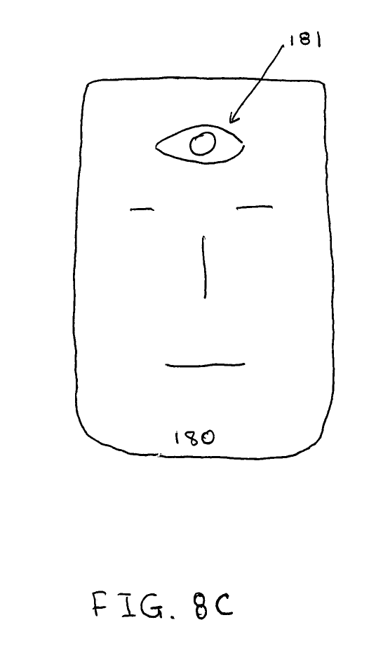

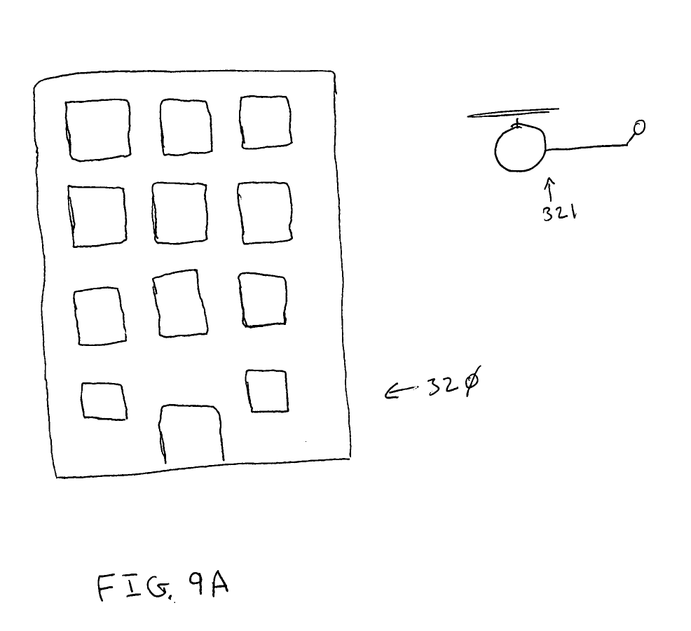

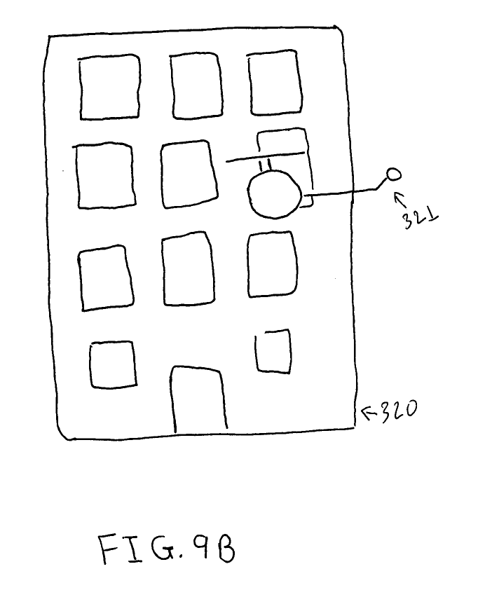

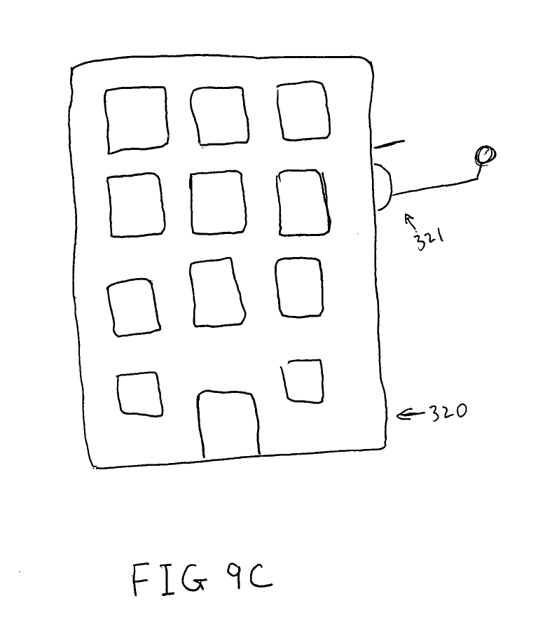

2. FIG. 2 shows cameras 111 and 112, or a specially designed camera 114, which are used to film the same subject object; camera 110 captures the invisible colors and the other camera 111 only captures colors in the human range of color perception. Each frame of the captured object is merged (to provide state) and given a behavior; this process results in at least one OOP object that is visually consistent with the image captured by camera 111; while this explanation contemplates the resolved image being converted into an OOP object, the process contemplates the resolved image being anything capable of being manipulated by computers or similar device. While the explanation of the preceding sentence contemplates use of a specially designed camera, or any set of paired cameras tasked to capture the images given by a subject object that has been treated to reflect invisible light, and have those images converted into an OOP object or similar program is contemplated by this process and system. The process also contemplates use of visible colors, for example red and blue, which composes the color rose.
3. Generally, this description of the process will refer to four “objects”: a “subject object” (which can be a real or model object), which will be colored with the invisible pigment(s), dyes or light, and captured on film; the image or “captured object” is the captured image of the object before it becomes an OOP object capable of behavior(s) or a similar programmable object; the “OOP object” which is the object that is undergoing manipulation, including morphing, receiving new programming, and/or new behaviors; and the “object manifestation,” which is the OOP object, or similar item, after it has been processed and reinserted into the film or other medium. Sometimes the term “OOP object” will be used to refer to an OOP manifestation, which is the representation of the OOP object in a particular frame. Thus, while either an OOP object or an OOP manifestation can be an OOP object, the term OOP manifestation only refers to what is in a particular frame.
4. Once the basic OOP object is created, it can be given other behaviors including scalability, relative physics, etc. The OOP object can also be given links to the Internet, intranets, WI-FI networks, etc. The OOP object can be given multiplicity, so that similar copies of the same OOP object can appear in the same frame; for example, an OOP raindrop can be multiplied to give the effect of rainfall, or an OOP insect can be multiplied to give the effect of a group of insects.
5. The computer manipulation/editing may be done by current programs and/or by a “special effects” software specifically designed to manipulate the OOP object, and/or a plurality of OOP manifestations to produce a third OOP manifestation.
6. While the preferred embodiment contemplates the invention being used for two dimensional film special effects, e.g., science fiction, horror movies, or educational or documentary films, the technology is also applicable to video games or any digital images, or analogue images, and to computing, audio, visual or tactile devices. Additionally, the invention may be used in three dimensional films or videogames.
7. In one embodiment the special effect requires the absence of something, for example a missing human forearm. In this embodiment, the virtually amputated arm will be painted with invisible pigment. For example, FIG. 3A shows that in the case of an amputated arm, the torso 121 need not be painted; Forearm 120 is painted with invisible pigment 101 and the amputation point 122 is painted with invisible pigment 102. During processing, the captured forearm 120 and amputation point 122 will be processed into two OOP objects; OOP forearm 120 will be eliminated from the digital file as shown on display 161, in FIG. 3B. FIG. 3C shows amputation point 122, which been treated with invisible pigment 102 and converted to an OOP object. The OOP object (amputation point 122) is subjected to an OOP special effect to color the cross-section area bounded by invisible pigment 102; the image manipulation program will place visible color 107 into the bound area, as shown on display 162.
8. In one embodiment the special effect requires simulation of invisibility or near invisibility of something, for example an invisible human limb. In this embodiment, the forearm 120 must be painted with invisible pigment. FIG. 3A shows the torso 121 need not be painted; Forearm 120 is painted with invisible pigment 101. During processing, the captured forearm 120 will be processed into an OOP object; the visibility of forearm 120 can be reduced using a Watermark like processing program. This same process, or another color altering program, can be used to change the color of the forearm 120. In all situations, once the change has been made to the OOP object, which OOP object has been inserted into the film as an OOP manifestation of forearm 120, all subsequent OOP manifestations of forearm 120 are automatically changed as needed. The change can also be made directly to the OOP manifestation.
9. In another embodiment, a human or animal body part might need to be morphed, for example (see FIG. 4) there may be a need for a three fingered alien hand with very long nails. In this embodiment, object hand 130 is painted with invisible pigment 101 and the fingers are bound to create a three finger look. The fingernails 132 are painted with invisible pigment 102. Once treated, the scene will be shot as normal, i.e., by camera 114, or by as set of paired cameras, to ensure hand 130's movements are captured. During film processing, captured hand 130 will be converted into an OOP object, then extracted from the film's digital file, and then morphed to appear as hand 131 with fingernails 134. This morphed OOP object is reinserted into the digital film file. The invention contemplates that each film frame following the insertion point, will be automatically changed so that the original subject object now appears as a three fingered alien hand with very long nails.
10. In one embodiment, the process can be applied to the manipulation of an object model. Here, as shown in FIG. 5, the object model spacecraft 140 has been painted with invisible pigments; part 141 was painted with pigment 103. Parts 142 and 143 are painted with invisible pigments 101 and 102, respectively. The interior 145 of model spacecraft 140 is painted with invisible pigment 104. The entire model spacecraft 140 is captured, as is interior 145. The four parts of object model spacecraft 140 rendered into four OOP objects, FIG. 5A represents the entire object craft 140; all OOP manifestations of the craft are stored in the database for later retrieval, where they resume OOP object status, or for later manipulation or use, as appropriate. Panel B of FIG. 5 represents damaged parts of the now OOP model spacecraft 140 being expelled by a computer generated explosion. Panel B shows the progress of OOP manifestations of OOP parts 142 and 143 by frame 151, by frame 152 and finally by frame 153 as these two OOP parts are being expelled from the OOP spaceship 140. Panel C of FIG. 5 shows OOP damaged spacecraft 141 and its exposed OOP interior 145, which had been treated with invisible pigment 104. Flight path 170 is a programmed flight path for the OOP damaged spacecraft 141. FIG. 6 shows the time and frames for several OOP manifestations of the OOP spacecraft as it follows flight path 170. FIG. 6 assumes the film was shot at 124 frames per second, but the process contemplates both faster and slow speeds. The flight path shows the path of the OOP spacecraft over 300 frames of film, which, as stated earlier, is displayed at 124 frames per second.
11. In one embodiment the process can be used to effect a common or an unusual morphing using destination models or mathematics, or both; but other techniques can be used to cause the morphing. The exteriors of object model solid balls 200, 201, 202, 203 and 204 in FIG. 7 are treated with invisible pigment 101 and each is captured by camera 114. The interiors of the model balls are treated with pigment 102. Object ball 201 becomes the morphing destination of object ball 200, object ball 202 becomes the morphing destination of object ball 201, object ball 203 becomes the morphing destination of object ball 202, and object ball 204 becomes the morphing destination of object ball 203. In this embodiment, four destination models were used. But, the method works with any number of destination models and at any scale. A non-limiting example of the point about scale could include the special effect of small pox marks on the face of an actor; in this case the actor's face could be spotted with invisible pigment(s); each small spot can be processed into an OOP object; each such OOP object can be an OOP pock mark.
12. In one embodiment the process can be used to add something to a subject. In FIG. 8, subject face 180 is treated with pigment 101. The relevant scene is shot for a two minute scene, or 14880 frames at 124 fps. OOP object 181 (an eye) is pulled from object library 182 and made into a 14880 frame object. OOP object 181, with or without special behaviors, is inserted over forehead 183 beginning at the first frame. The behaviors, if any, can include winking, blinking, weeping, changing of color, pupil dilation, pupil narrowing, etc. This embodiment allows any number of OOP object files or OOP manifestations for any number of frames to be placed into the subject image. This embodiment also allows any source combination of sources for the inserted OOP object. This embodiment also allows for any destination, and for any OOP object to be inserted.
13. In one embodiment one or more object(s) must interact with another object. In FIG. 9, two objects, model building 320 and model helicopter 321 are painted with invisible pigment 101 and 102, respectively. Each is captured by a paired camera and processed into OOP object building 320, and OOP object helicopter 321. Each object is programmed so that to the extent the OOP objects conflict, the OOP object in the foreground has preference. The OOP objects can then be inserted into the film (or other medium) and behave according to their programming. Thus, from the viewer's perspective (in Panel B of FIG. 9), virtual helicopter 321, which is flying in front of virtual building 320 will appear according to the normal laws of perspective. Object helicopter in FIG. 9C has “crashed” into object building 320. In this case, object building 320 has preference. From the viewer's perspective, object helicopter 321 is embedded into object building 320.
14. In one embodiment, OOP object files are created to be placed in an object file library or database. Objects withdrawn from the library/database can be given new behaviors so that it can perform in the new medium or new tasks.
15. In another embodiment, the OOP object can be programmed to link to any website or linked computer, or to provide a menu of links to many websites.

We claim:

1. The filming process comprising: the coloring of subject objects with a plurality of different colors; capturing the subject object with at least one set of paired cameras; tracking each subject object; transferring the capture images to a subsystem; resolving the two sets of images by use of pattern recognition software; giving each resolved image behavior so that the resulting image becomes an OOP object; storing the OOP object in a database for later retrieval; and use of OOP-based programming to manipulate the OOP object.

2. The process of claim one wherein the coloring of the subject objects further comprises use of at least one of the colors being a color that is not visible to the human eye.

3. The process of claim one wherein the paired cameras further comprises one camera of the paired cameras being capable of capturing colors invisible to the human eye and the other camera being capable of capturing only colors visible to the human eye.

4. The process of claim one wherein the subject objects include any condensed matter capable of being colored.

5. The process of claim one wherein tracking further comprises tracking each subject object based on the color and the predefined spatial relationship between the subject objects.

6. The product OOP object of claim one further comprising the digital manipulation effecting links to the group consisting of the Internet, intranets, local area networks and WI-Fl networks.

7. The product OOP object of claim one further comprising the digital manipulation effecting a further morphing of the OOP object.

8. The system comprising: the group consisting of pigments, dyes and light; paired cameras that detect two different sets of colors and captures these colors on two different sets of film capable of recording visual images; and a subsystem to receive the images, process the images into OOP objects, store the images, facilitate retrieval of the processed images for further processing and retrieval for further use.

9. The system of claim seven further comprising the group of pigments, dyes and light that are visible to the human eye and pigments and dyes that are not visible to the human eye.

10. The system of claim seven wherein one camera of each pair of cameras is capable of capturing colors invisible to the human eye and the other camera of each pair is capable of only capturing the group of colors visible to the human eye.

11. The system of claim seven wherein the subsystem further comprises use of pattern recognition to process images of the subject object into OOP objects.

12. The system of claim eleven wherein the retrieval of the processed images for further processing further comprises use of OOP-based software to further process the OOP object.
